(19) United States
(12) Patent Application Publication
(10) Pub. No.: US 2003/0236826 A1
(43) Pub. Date: Dec. 25, 2003

(54) System and method for making mobile applications fault tolerant

(76) Inventors: Nayeem Islam, Palo Alto, CA (US); Shahid Shoaib, San Jose, CA (US)

Correspondence Address: BRINKS HOFER GILSON & LIONE, P.O. BOX 10395, CHICAGO, IL, 60610, US

(21) Appl. No.: 10/179,994

(22) Filed: Jun. 24, 2002

(51) Int. Cl. G06F 15/16

(52) U.S. Cl. 709/203

(57) ABSTRACT

In one aspect of the invention, a fault tolerant system for recovering from transient faults in a mobile computing environment is provided. The fault tolerant system comprises a configurable reliable messaging system, which includes a client computer operative to generate a message and a server computer operative to receive the message and to generate a reply in response to the message across a communication network. The messaging system also includes a client logging agent on the client operative to buffer the message in a persistent storage on the client and to transmit the message to the server until the reply is received. The client logging agent executes in response to a client logging signal. The messaging system further includes a server logging agent on the server operative to buffer the received message and the reply in a persistent storage on the server and to transmit the reply to the client. The server logging agent executes in response to a server logging signal. In addition, the messaging system includes a configuration agent operative to generate the client and server logging signals to selectively enable the client and server logging agents. The fault tolerant system further comprises a recoverable runtime engine for managing a lifecycle of at least one application executing in the mobile computing environment. The runtime engine is operative to save and restore an execution state to restart execution of the application following the transient faults.

### RELATED APPLICATION

This application is related to Application No. ______, Attorney Docket No. 10745/112, filed Jun. 20, 2002, entitled “Mobile Application Environment,” naming as inventors Nayeem Islam and Shahid Shoaib, filed the same date as the present application. That application is incorporated herein by reference for all purposes as if fully set forth herein.

### FIELD OF THE INVENTION

The present invention relates generally to a mobile computing environment. In particular, it relates to a mobile application computing that is configurably fault tolerant.

### BACKGROUND

The need for mobile computing and network connectivity are among the main driving forces behind the evolution of computing devices today. The desktop personal computer (PC) has been transformed into the portable notebook computer. More recently, a variety of handheld consumer electronic and embedded devices, including Personal Digital Assistants (PDAs), cellular phones and intelligent pagers have acquired relatively significant computing ability. In addition, other types of mobile consumer devices, such as digital television settop boxes, also have evolved greater computing capabilities. Now, network connectivity is quickly becoming an integral part of these consumer devices as they begin speaking with each other and traditional server computers in the form of data communication through various communication networks, such as a wired or wireless LAN, cellular, Bluetooth, 802.11b (Wi-Fi) wireless, and General Packet Radio Service (GPRS) mobile telephone networks.

The evolution of mobile computing devices has had a significant impact on the way people share information and is changing both personal and work environments. Traditionally, since a PC was fixed on a desk and not readily movable, it was possible to work or process data only at places where a PC with appropriate software was found. Nowadays, however, the users of mobile computing devices can capitalize on the mobility of these devices to access and share information from remote locations at their convenience.

The first generation mobile devices typically were request-only devices or devices that could merely request services and information from more intelligent and resource rich server computers. Today, with the advent of more powerful computing platforms aimed at mobile computing devices, such as PocketPC and Java 2 Platform, Micro Edition (J2ME), mobile devices have gained the ability to host and process information and to participate in more complex interactive transactions.

With greater demands being placed on mobile application environments, transient failures in mobile devices, mobile communication networks and servers pose increasing challenges to application developers. However, conventional mobile application platforms fail to provide satisfactory services for making mobile computing environments sufficiently fault tolerant to transient failures in a system, while recognizing that recovery operations may have performance costs that could outweigh the benefits of recovery.

Therefore, in the area of mobile computing environments for mobile devices there continues to be a need for a configurable fault tolerant system to make mobile application environment more robust.

### SUMMARY

In one aspect of the invention, a fault tolerant system for recovering from transient faults in a mobile computing environment is provided. The fault tolerant system comprises a configurable reliable messaging system, which includes a client computer operative to generate a message and a server computer operative to receive the message and to generate a reply in response to the message across a communication network. The messaging system also includes a client logging agent on the client operative to buffer the message in a persistent storage on the client and to transmit the message to the server until the reply is received. The client logging agent executes in response to a client logging signal. The messaging system further includes a server logging agent on the server operative to buffer the received message and the reply in a persistent storage on the server and to transmit the reply to the client. The server logging agent executes in response to a server logging signal. In addition, the messaging system includes a configuration agent operative to generate the client and server logging signals to selectively enable the client and server logging agents. The fault tolerant system further comprises a recoverable runtime engine for managing a lifecycle of at least one application executing in the mobile computing environment. The runtime engine is operative to save and restore an execution state to restart execution of the application following the transient faults.

### BRIEF DESCRIPTION OF THE DRAWINGS

FIG. 1 is an illustrative mobile computing environment for implementing an embodiment of the fault tolerance system to recover from transient system faults according to the present invention;

FIG. 2 is a diagram showing the structure of a message for a reliable messaging system of the fault tolerance system of FIG. 1;

FIG. 3 is a chart showing details of the operation of the reliable messaging system of FIG. 2; and

FIG. 4 is a table showing different configurations and the associated performance costs for the reliable messaging system of FIG. 2.

### DETAILED DESCRIPTION OF THE PREFERRED EMBODIMENTS

Reference will now be made in detail to an implementation of the present invention as illustrated in the accompanying drawings. The preferred embodiments of the present invention are described below using a Java based software system. However, it will be readily understood that the Java based software system is not the only vehicle for implementing the present invention, and the present invention may be implemented under other types of software systems.

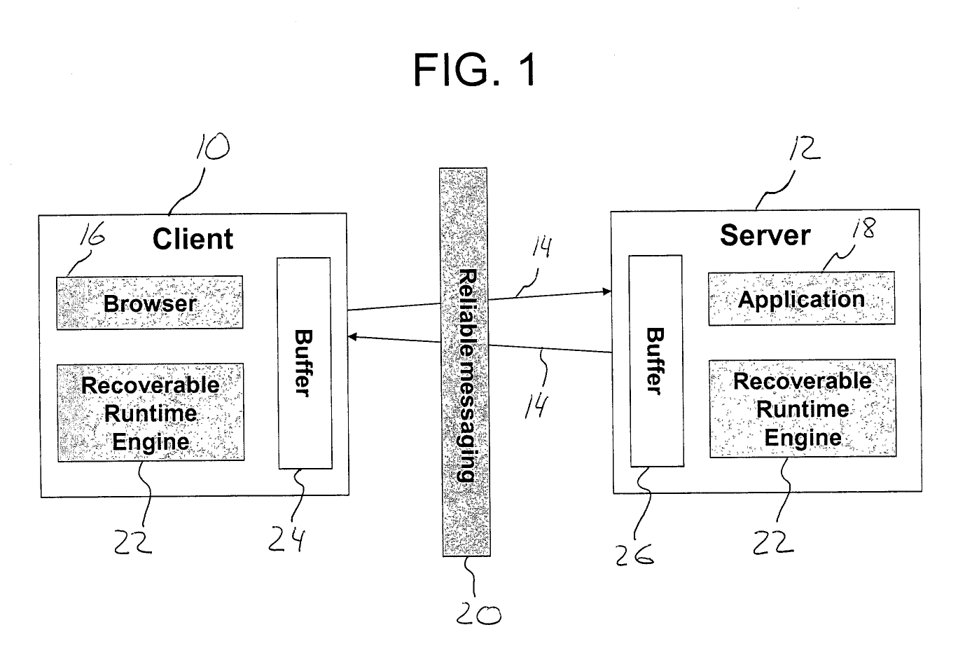

An illustrative mobile computing environment in which an embodiment of the invention may be implemented to recover from transient system faults is shown in FIG. 1. In the exemplary environment, a mobile client device 10 and a server device 12 communicate over a mobile communication network 14, such as when a user interacts with the mobile client device 10 through a client application or browser 16 to request content of an application 18 from the server 12. A fault tolerance system for a mobile application environment according to the present invention takes into consideration that any one of three components may fail: the client 10, the network 14 or the server 12. It is assumed that all faults are transient and persistent storage on the client and on the server 12 will survive a crash. In order to recover from transient faults, the fault tolerance system includes a reliable messaging system 20. The reliable messaging system 20 can guarantee that messages in transit will be delivered with at least once semantics. The reliable messaging system 20 may be configured to recover messages as follows: no fault tolerance, recoverable from client and network faults, and recoverable from client, network and server faults.

The fault tolerance system may additionally include a recoverable runtime engine 22 for a mobile application 18 that can be configured to resume execution of a set of applications 18 that were running on a client or server device at the time of a crash.

1. Reliable Messaging System

The reliable messaging system 20 according to the present invention can utilize various messaging protocols to deliver the contents of an application 18 in a network 14 and is not limited to the HTTP protocol. For example, types of messaging protocols that have been found useful include one-way and request-response protocols, which could be synchronous or asynchronous. The reliable messaging system 20 is fault tolerant because it ensures that messaging transactions in progress will be preserved. However, the reliable messaging system 20 is not responsible for recovering applications themselves following device failures.

In particular, the reliable messaging system 20 has a queue or buffer on the client side 24 such that all outgoing communication from the client 10 is buffered in persistent storage. The buffer has a user configurable size. Also, each message is tagged with a unique sequence number and a reply is sought for each element. If a reply is not received, the message is retransmitted until a reply is received. When the reply is received, the appropriate buffered message is released from the system. Likewise, the reliable messaging system 20 has a queue or buffer on the server side 26 such that all outgoing communication from the server 12 is buffered in persistent storage.

The reliable messaging system 20 can be implemented such that a reply is tied either to the underlying operating software of a device or to a higher level event in the application 18. For general application communication, the generic form is used where the reply is tied to the underlying operating software. For system level reliable communication, the buffering mechanism is tied to the request being received by the runtime engine 22.

In order to implement the reliable messaging system 20, the API is provided with the following method for generating requests to and responses from an application 18:

void Reliable_async_send (Endpoint to, Endpoint From,
MessageData Data,
Reliability Type, Callbackmethod cm)

The “to” field identifies the receiver. The “from” field identifies the sender. The “data” field is the serialized data being sent. The data format for this method can be the same as that for HTTP-mime encoded interfaces, but those skilled in the art will readily recognize that other implementations are possible with different exchange formats. The “type” is either application level or system level. A callback method is called when an acknowledgement is received. Using this API, the reliable messaging system 20 can guarantee at least one delivery of a message.

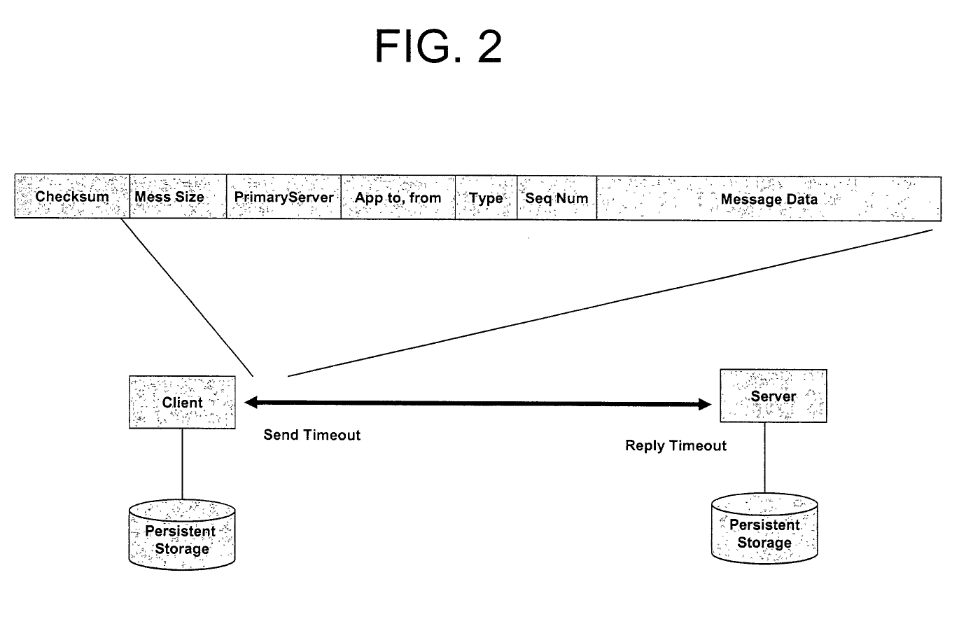

The message format for the reliable messaging system 20 is shown in FIG. 2. It has a total of six fields, where the first four are fixed size, the data segment is variable size, and the checksum is variable and computed over all the fields.

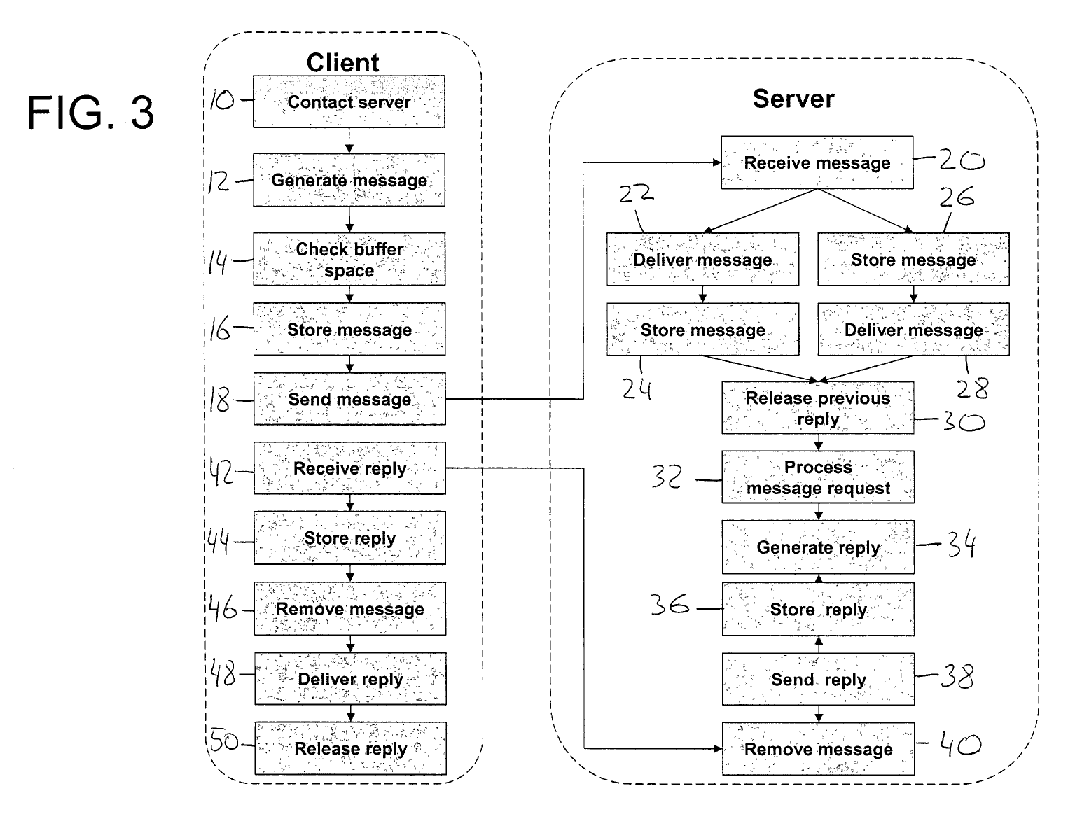

In operation, the reliable messaging system 20 manages the connection between a client device 10 and a server 12 as shown in FIG. 3. The system periodically wakes up and performs the following task in step 10. It checks to see if the server 12 can be contacted through any of the client's access networks, such as Bluetooth, 802.11b (Wi-Fi) wireless, IRDA, and General Packet Radio Service (GPRS) mobile telephone networks 802.11b. It does this by sending an ICMP Ping to the server 12. The first access network that provides a match is used for further communication. The reliable messaging system 20 also wakes up a buffer management thread and tells it which protocol to use to communicate with the server 12.

A client 10 sends a message to an application 18 on a server 12 using the reliable messaging system 20 by calling the method Reliable_async_send( ) in step 12. Each time a message is sent, the reliable messaging system 20 on the client 10 checks to see if there is free buffer space on a persistent storage of the client, such as a flash memory or micro-drive in step 14. The maximum buffer space is set to a predetermined value, MAX_BUF, by the system administrator. If there is sufficient buffer space available, the message is buffered and a buffer manager of the reliable messaging system 20 attaches a sequence number to the message in step 16. All messages are sent with unique sequence numbers between two pairs of machines. Once the message is buffered, the call can return to the client 10. The call does not return to the client 10 until the message has been buffered to a persistent storage. After the call returns, the client 10 is assured that the message will be delivered to the appropriate application 18 even if the client device 10 or network 14 fails.

Periodically, the buffer management thread on the client 10 wakes up and sends the buffered messages to the server 12 and waits for replies to messages previously sent in step 18. Each message has a predetermined timeout value associated with it. If a reply message has not been received within the timeout period, then the message is resent. This process continues until a reply has been received. The buffer management thread is only triggered when the network 14 is up and a path to the server 12 has been established.

On receipt of a request message on the server 12 in step 20, the system administrator can choose how the reliable messaging system 20 should process and deliver the message to the application 18 on the server 12. For example, the system can immediately deliver the message to the application 18 in step 22 and then store the message to a persistent storage in step 24, such as a hard disk. This increases the time the message is not in a “safe” state, but it gives the application 18 quick access to the message.

Alternatively, on receiving the message, the reliable messaging system 20 on the server 12 can log it in a persistent storage in step 26 and then deliver it to the application 18 in step 28. The application 18 then processes the message (step 32) and generates a reply (step 34). It also signals to the reliable messaging system 20 that it has responded. The system logs the reply in step 36 and then attempts to send it to the requesting client 10 in step 38. At this point, the request message is removed from the persistent storage buffer on the server 12 in step 40.

The client 10 on receiving the reply (step 42) immediately stores the reply in a buffer on persistent storage (step 44). It then finds the matching request message that was- sent to the server 12,and removes it from the buffer in step 46. Next, the client 10 attempts to deliver the reply to the appropriate callback method from the client application 16 in step 48. Once the callback method is called, the reply is released in step 50. On the server 12, the buffer for the reply will be released when the next message is received from the same client with a higher sequence number in step 30. If a duplicate message is received by the server 12, then it is discarded. The size of the acknowledgement buffer is set by the systems administrator to ACK_BUF.

1.1 Configurability

The fault tolerance system characterizes the various faults in the mobile system based on cost associated with component recovery. It then allows a system administrator to choose the components to recover from. The tradeoff is that fault tolerance has performance implications that must be weighed against the reliability that is required.

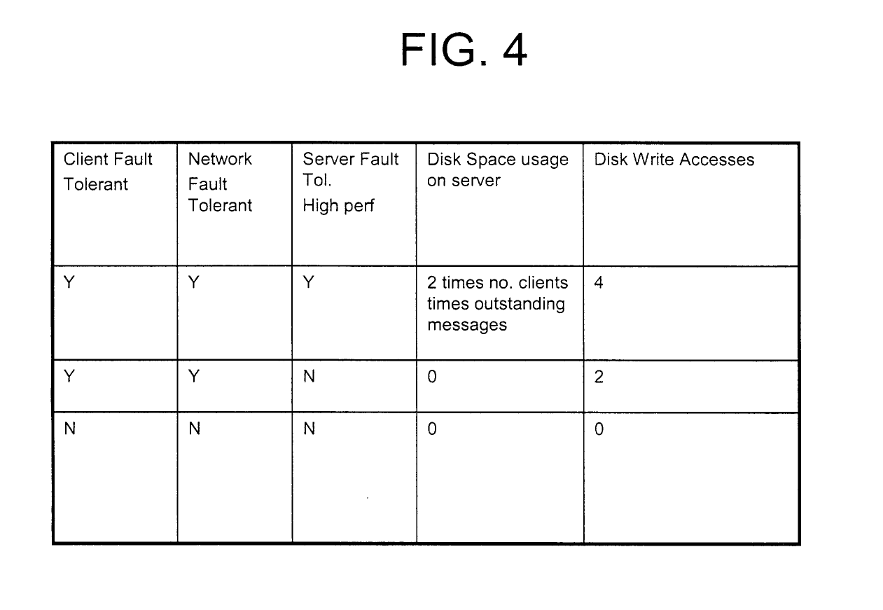

In particular, fault tolerance comes at a cost since all writes to a disk cost time and disk space. Referring next to FIG. 4, several configurations for the implementation of the reliable messaging system 20 are shown. The first row describes a technique where messages are logged on the server 12 and client 10, the second describes messages being logged solely on the client 10, and the third row describes a technique where no messages are logged. The first two options offer the following alternatives for fault tolerance. If a user desires to lower the runtime costs and is willing to spend more time in recovering an application 18, then the second option may be considered. The first option has higher runtime costs because messages are logged on the client 10 and the server 12, but the benefit to the user is that recovery for the application 18 using the reliable messaging system 20 is made more robust.

2. Recoverable Runtime Engine

Applications 18 execute under the control of a runtime engine 22 via a set of application programming interfaces (APIs) encapsulated in a set of class libraries. For example, Java based mobile applications can run on the J2ME CDC platform using J2ME libraries, which provide access to Java Virtual Machine (JVM), PersonalJava Virtual Machine (PJVM) or other type of Virtual Machine (VM). VM, which runs on top of the native operating system of a device, acts like an abstract computing machine, receiving Java bytecodes and interpreting them by dynamically converting them into a form for execution by the native operating system.

A recoverable runtime engine 22 according to the present invention can restore its own state to restart the set of applications 18 that it was executing on a device at the time of a crash by instrumenting its class libraries with the following method:

Void Restore(ApplicationContext m)

Additionally, the following method can be implemented to allow each application 18 to recover its own state prior to a crash:

Void Save( )

The runtime engine 22 periodically stores its state on persistent storage, including a list of all currently executing applications 18 and the most recent application context for each. The list may also contain the priority of each application 18. In addition, the runtime engine 22 can at any time call the method Save( ) on an application 18 to save the application state into persistent storage.

The runtime engine 22 can restore its own state to restart the set of applications 18 that it was executing on a device at the time of a crash. The engine 22 will restart each application 18 on its list one at a time. The order for restarting the applications 18 may depend on their priorities. An application 18 can register the method Restore(ApplicationContext) with the runtime engine 22 when the application 18 is restarted following a device failure. This method is preferably called before the application 18 is initialized. The data object ApplicationContext includes data from the runtime engine's list that identifies the application 18 and its context. The method Restore(ApplicationContext) can implement application specific recovery operations, including reading the state of local communication buffers to identify the communication state of the reliable messaging system 20 for the application 18 on the device. It can also query the communication state of the reliable messaging system 20 for the application 18 on the server 12. The method can return control to the runtime engine 22 after an application 18 has been restored.

Applications 18 are responsible for recovering their own state to resume execution. The method Save( ) is made available to applications to allow them to save their state at any time.

3. Handling Failures

When a server 12 recovers from a failure, it looks at the buffer list on its persistent storage. The reliable messaging system 20 assumes that data on the persistent storage of the device is not destroyed, but data in main memory of the device is destroyed. If the list contains a message from a client 10, then the reliable messaging system 20 assumes that the request has not been processed and attempts to deliver the message to the appropriate application 18. Likewise, if the server 12 finds a buffered reply after recovery from a crash, the system sends it to the appropriate client 10.

In order for applications 18 to successfully recover from transient device and network faults using the fault tolerance system according to the present invention, the following sequence of recovery operations is used:

1) The reliable messaging system 20 comes to a consistent state.

2) A caching infrastructure, if any, is brought to consistent state.

3) The runtime engine 22 comes to a consistent state.

4) The individual applications 18 are sequentially brought to a consistent state.

Although the invention has been described and illustrated with reference to specific illustrative embodiments thereof, it is not intended that the invention be limited to those illustrative embodiments. Those skilled in the art will recognize that variations and modifications can be made without departing from the true scope and spirit of the invention as defined by the claims that follow. It is therefore intended to include within the invention all such variations and modifications as fall within the scope of the appended claims and equivalents thereof.

We claim:

1. A fault tolerant system for recovering from transient faults in a mobile computing environment comprising:
a configurable reliable messaging system, said messaging system including:
a client computer operative to generate a message;
a server computer operative to receive said message and to generate a reply in response to said message across a communication network;
a client logging agent on said client operative to buffer said message in a persistent storage on said client and to transmit said message to said server until said reply is received, said agent selectively executing in response to a client logging signal;
a server logging agent on said server operative to buffer said received message and said reply in a persistent storage on said server and to transmit said reply to said client, said agent selectively executing in response to a server logging signal;
a configuration agent operative to generate said client and server logging signals to selectively enable said client and server logging agents; and
a recoverable runtime engine for managing a lifecycle of at least one application executing in said mobile computing environment, said runtime engine operative to save an execution state and restore said execution state to restart execution of said at least one application following said transient faults.
